(19) United States
(12) Patent Application Publication
(10) Pub. No.: US 2010/0096459 A1
(43) Pub. Date: Apr. 22, 2010

(54) Electro-optical reader with extended working range

(76) Inventor: Vladimir Gurevich, Stony Brook, NY (US)

Correspondence Address: MOTOROLA, INC., 1303 EAST ALGONQUIN ROAD, IL01/3RD, SCHAUMBURG, IL, 60196, US

(21) Appl. No.: 12/288,128

(22) Filed: Oct. 16, 2008

(51) Int. Cl. G06K 7/10

(52) U.S. Cl. 235/455

(57) ABSTRACT

A reader for, and a method of, electro-optically reading a symbol in a range of working distances include a housing, a data capture assembly supported by the housing for directing light at a variable power level at the symbol in a plurality of successive scans, and for detecting return light from the symbol, and a controller for controlling the data capture assembly by increasing the power level of the light during at least one of the successive scans to enable detection of the symbol located at an increased working distance from the reader, and by decreasing the power level of the light during at least another of the successive scans to maintain an output power level within safety limits. Preferably, the increased power level alternates with the decreased power level during successive scans.

### DESCRIPTION OF THE RELATED ART

Moving laser beam readers or laser scanners, as well as solid-state imaging systems or imaging readers, have both been used to electro-optically read one-dimensional bar code symbols, particularly of the Universal Product Code (UPC) type, each having a row of bars and spaces spaced apart along one direction, and two-dimensional symbols, such as Code 49, which introduced the concept of vertically stacking a plurality of rows of bar and space patterns in a single symbol, as described in U.S. Pat. No. 4,794,239. Another two-dimensional code structure for increasing the amount of data that can be represented or stored on a given amount of surface area is known as PDF417 and is described in U.S. Pat. No. 5,304,786.

Moving laser beam readers generally include a laser for emitting a laser beam, a focusing lens assembly for focusing the laser beam to form a beam spot having a certain size at a focal plane in a range of working distances, a scan component for repetitively scanning the beam spot across a target symbol in a scan pattern, for example, a scan line or a series of scan lines, across the target symbol multiple times per second, e.g., forty times per second, a photodetector for detecting light reflected and/or scattered from the symbol and for converting the detected light into an analog electrical signal, and signal processing circuitry including a digitizer for digitizing the analog signal, and a microprocessor for decoding the digitized signal based upon a specific symbology used for the symbol.

The imaging reader includes a solid-state imager or sensor having an array of cells or photosensors, which correspond to image elements or pixels in a field of view of the imager, an illuminating light assembly for illuminating the field of view with illumination light from an illumination light source, e.g., a laser or one or more light emitting diodes (LEDs), and an imaging lens assembly for capturing return ambient and/or illumination light scattered and/or reflected from the symbol being imaged over a range of working distances. Such an imager may include a one- or two-dimensional charge coupled device (CCD) or a complementary metal oxide semiconductor (CMOS) device and associated circuits for producing electronic signals corresponding to a one- or two-dimensional array of pixel information over the field of view.

It is therefore known to use the imager for capturing a monochrome image of the symbol as, for example, disclosed in U.S. Pat. No. 5,703,349. It is also known to use the imager with multiple buried channels for capturing a full color image of the symbol as, for example, disclosed in U.S. Pat. No. 4,613,895. It is common to provide a two-dimensional CCD with a 640×480 resolution commonly found in VGA monitors, although other resolution sizes are possible.

As advantageous as both types of readers are in reading symbols, it is desirable in many applications to increase the range of working distances at which symbols can be read. Increasing the intensity or brightness of the laser beam in the moving laser beam reader will increase the working distance range, because there will be correspondingly more return light to detect from symbols that are further away from the moving laser beam reader. However, increasing the laser beam intensity too much may violate human eye exposure laser safety standard limits. For example, a class 2 laser is limited to an output power of 1 mW over a base time interval of 250 msec, and a class 1 laser is limited to an output power of 0.39 mW over a base time interval of 10 sec. The laser beam intensity cannot exceed these limits.

Similarly, increasing the intensity or brightness of the laser or LED illumination light in the imaging reader will increase the working distance range, because there will be correspondingly more return light for the imager to detect from symbols that are further away from the imaging reader. LEDs, just like lasers, are subject to human eye exposure safety standard limits, which cannot be exceeded.

For increased safety, the art has proposed maintaining the output power level of the laser or LED such that the output power does not exceed these limits. For example, the output power level of the laser is kept constant and the same for each scan line in the moving laser beam reader. However, as noted above, this reduces the working distance range and degrades reader performance.

Accordingly, there is a need for a system for, and a method of, enhancing the working distance range of such readers, without violating human eye exposure safety limit standards.

### SUMMARY OF THE INVENTION

One feature of this invention resides, briefly stated, in reader for electro-optically reading a target, such as one- and/or two-dimensional bar code symbols, as well as non-symbols, in an extended range of working distances. The reader includes a housing, preferably one having a handle for handheld operation; a data capture assembly supported by the housing and operative for directing light at a variable power level at the target in a plurality of successive scans, and for detecting return light from the target; and a controller for controlling the data capture assembly by increasing the power level of the light during at least one of the successive scans to enable detection of the target located at an increased working distance from the reader, and by decreasing the power level of the light during at least another of the successive scans to maintain an output power level within safety limits.

In one embodiment, the reader is a moving laser beam reader, which includes a laser for emitting the light as a laser beam, a scanner for sweeping the laser beam across the target as a plurality of scan lines for reflection and scattering as the return light, and a detector for detecting the return light. The controller is operative for driving the laser at an increased power level during the at least one scan, and at a decreased power level during the at least other scan. Preferably, the controller is operative for driving the laser to alternate between the increased power level and the decreased power level during the successive scans. Advantageously, the increased power level is a higher constant and the same during a first group of the alternate scans, and the decreased power level is a lower constant and the same during a second group of the alternate scans.

In another embodiment, the reader is an imaging reader, which includes an illuminator for emitting the light as illumination light that illuminates the target, and a solid-state imager, such as a charge coupled device (CCD) or a complementary metal oxide semiconductor (CMOS) device, for detecting the return illumination light in successive exposures. The controller is operative for driving the illuminator at an increased power level during at least one exposure, and at a decreased power level during at least another exposure. Preferably, the controller is operative for driving the illuminator to alternate between the increased power level and the decreased power level during the successive exposures. Advantageously, the increased power level is a higher constant and the same during a first group of the alternate exposures, and the decreased power level is a lower constant and the same during a second group of the alternate exposures.

Hence, in accordance with this invention, the increased output power level of the laser or LED increases the working range, and the decreased output power level of the laser or LED insures that the output power does not exceed human eye exposure safety limit standards. Reader performance is enhanced.

Another feature of this invention resides, briefly stated, in a method of electro-optically reading a target in a range of working distances from a reader, the method being performed by directing light at a variable power level at the target in a plurality of successive scans, detecting return light from the target, increasing the power level of the light during at least one of the successive scans to enable detection of the target located at an increased working distance from the reader, and decreasing the power level of the light during at least another of the successive scans to maintain an output power level within safety limits. Advantageously, the increasing and decreasing steps are alternately performed.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic diagram of a handheld moving laser beam reader for electro-optically reading a target in accordance with the present invention;

FIG. 2 is a schematic diagram of a handheld imaging reader for electro-optically reading a target in accordance with the present invention;

FIG. 3 is a graph depicting output light levels of the reader of FIG. 1 or FIG. 2 over successive scans or exposures in accordance with the prior art; and

FIG. 4 is a graph depicting output light levels of the reader of FIG. 1 or FIG. 2 over successive scans or exposures in accordance with the present invention.

### DETAILED DESCRIPTION OF THE PREFERRED EMBODIMENTS

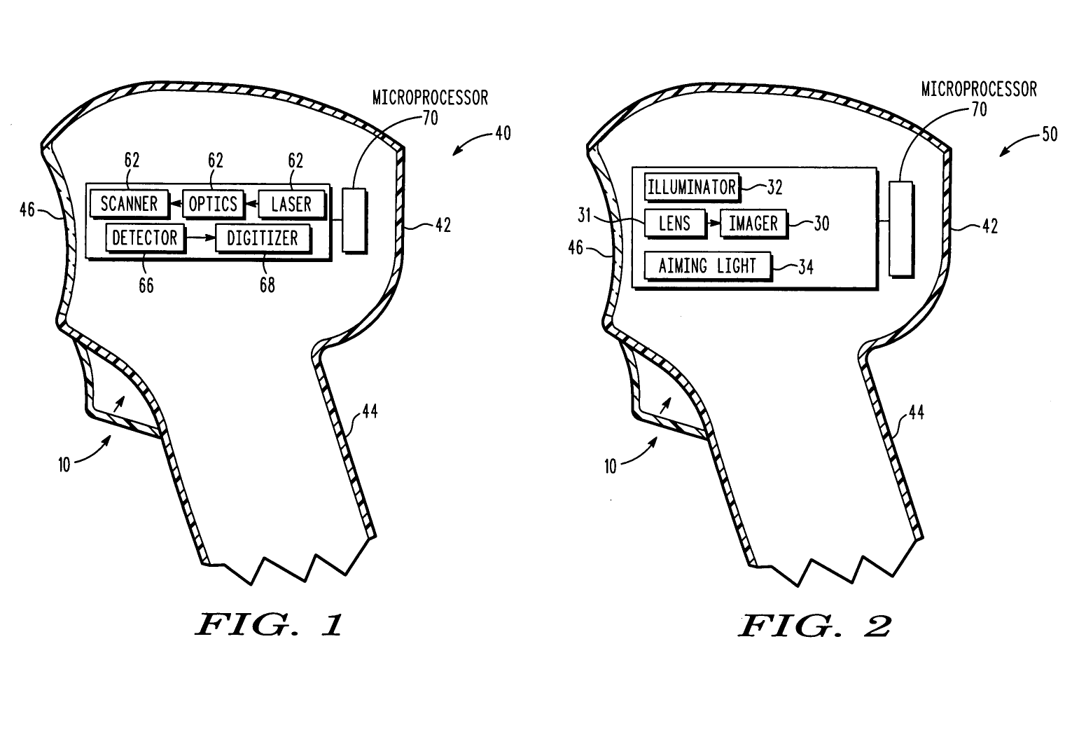

FIG. 1 depicts a moving laser beam reader 40 for electro-optically reading a target or indicia, such as a symbol, that may use, and benefit from, the present invention. The beam reader 40 includes a scanner 62 in a handheld housing 42 having a handle 44 on which a trigger 10 for initiating reading is mounted. The scanner 62 is operative for scanning an outgoing laser beam from a laser 64 and/or a field of view of a light detector or photodiode 66 in a scan pattern, typically comprised of one or more scan lines, multiple times per second, for example, forty times per second, through a window 46 across the symbol for reflection or scattering therefrom as return light detected by the photodiode 66 during reading. The beam reader 40 also includes a focusing lens assembly or optics 61 for optically modifying the outgoing laser beam to have a large depth of field, and a digitizer 68 for converting an electrical analog signal generated by the detector 66 from the return light into a digital signal for subsequent decoding by a microprocessor or controller 70 into data indicative of the symbol being read.

FIG. 2 depicts an imaging reader 50 for imaging targets, such as indicia or symbols to be electro-optically read, as well as non-symbols, which may use, and benefit from, the present invention. The imaging reader 50 includes a one- or two-dimensional, solid-state imager 30, preferably a CCD or a CMOS array, mounted in the handheld housing 42 having the handle 44 on which the trigger 10 for initiating reading is mounted. The imager 30 has an array of image sensors operative, together with an imaging lens assembly 31, for capturing return light reflected and/or scattered from the target through the window 46 during the imaging to produce an electrical signal indicative of a captured image for subsequent decoding by the controller 70 into data indicative of the symbol being read, or into a picture of the target.

When the reader 50 is operated in low light or dark ambient environments, the imaging reader 50 includes an illuminator 32 for illuminating the target during the imaging with illumination light directed from an illumination light source through the window 46. Thus, the return light may be derived from the illumination light and/or ambient light. The illumination light source comprises one or more light emitting diodes (LEDs) or a laser. An aiming light generator 34 may also be provided for projecting an aiming light pattern or mark on the target prior to imaging.

In operation of the imaging reader 50, the controller 70 sends a command signal to drive the illuminator LEDs/laser 32 for a short time period, say 500 microseconds or less, and energizes the imager 30 during an exposure time period of a frame to collect light from the target during said time period. A typical array needs about 33 milliseconds to read the entire target image and operates at a frame rate of about 30 frames per second. The array may have on the order of one million addressable image sensors.

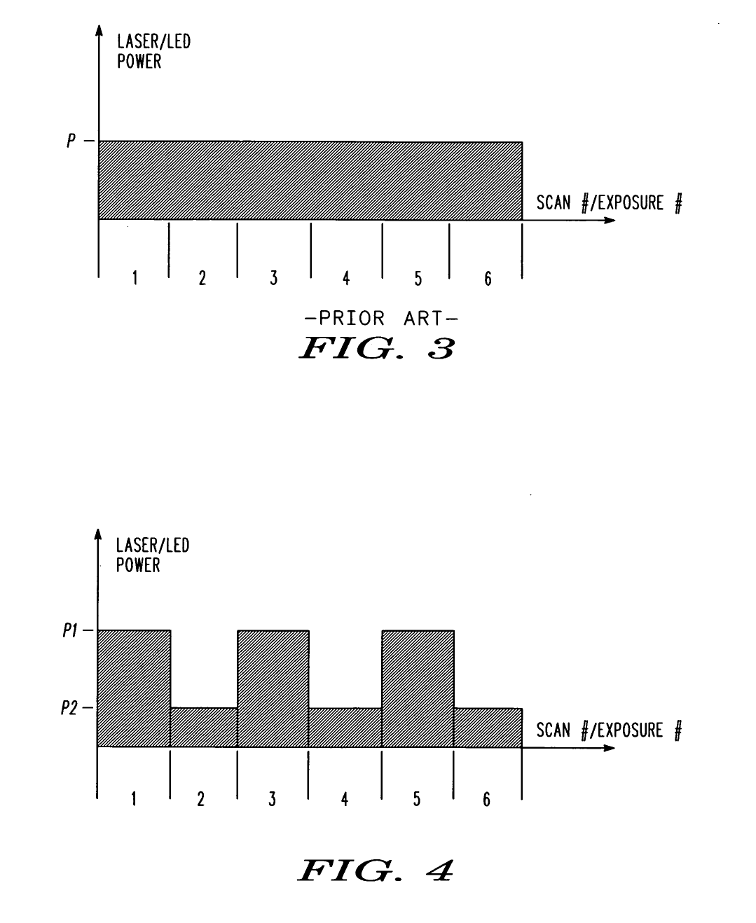

Turning to FIG. 3, it is conventional that the controller 70 drive the laser 64 or the illuminator LEDs/laser 32 at a constant output power level “P” to direct light at the target over a plurality of successive laser scans or imager exposures. The output power level “P” is selected such that established human eye exposure safety standard limits are not exceeded. For example, a class 2 laser is limited to an output power level of 1 mW over a base time interval of 250 msec, and a class 1 laser is limited to an output power level of 0.39 mW over a base time interval of 10 sec. FIG. 3 depicts that for the first six scans, the output power level “P” is constant for each scan.

In accordance with the present invention, as shown in FIG. 4, the controller 70 drives the laser 64 or the illuminator LEDs/laser 32 by increasing the power level of the light during at least one of the successive laser scans or imager exposures to an output power level “P1” to enable detection of the target located at an increased working distance from the reader, and by decreasing the power level of the light during at least another of the successive laser scans or imager exposures to an output power level “P2” to maintain an output power level within the aforementioned safety limits.

Preferably, the controller 70 is operative for driving the laser 64 or the illuminator LEDs/laser 32 to alternate between the increased power level “P1” and the decreased power level “P2” during the successive scans. Advantageously, the increased power level “P1” is a higher constant and the same during a first group of the alternate scans, i.e., the odd-numbered scans or exposures, and the decreased power level “P2” is a lower constant and the same during a second group of the alternate scans scans, i.e., the even-numbered scans or exposures. The area under the graph of FIG. 4 is about the same as the area under the graph of FIG. 3, thereby insuring that the output power is the same and that the safety limits are not exceeded.

Hence, in accordance with this invention, the increased output power level “P1” of the laser 64 or the illuminator LEDs/laser 32 increases the working range, and the decreased output power level “P2” of the laser 64 or the illuminator LEDs/laser 32 insures that the output power does not exceed human eye exposure safety limit standards. Reader performance is enhanced.

It will be understood that each of the elements described above, or two or more together, also may find a useful application in other types of constructions differing from the types described above.

While the invention has been illustrated and described as embodied in electro-optical readers, it is not intended to be limited to the details shown, since various modifications and structural changes may be made without departing in any way from the spirit of the present invention. For example, the pattern depicted in FIG. 4 can be changed. For example, the increased power level can be generated every second or third scan/exposure. Also, there can be more than the illustrated two power levels.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A reader for electro-optically reading a target in a range of working distances, comprising:
a housing,
a data capture assembly supported by the housing for directing light at a variable power level at the target in a plurality of successive scans, and for detecting return light from the target; and
a controller for controlling the data capture assembly by increasing the power level of the light during at least one of the successive scans to enable detection of the target located at an extended working distance from the reader, and by decreasing the power level of the light during at least another of the successive scans to maintain an output power level within safety limits.

2. The reader of claim 1, wherein the housing has a handle held by an operator during the reading, and a trigger mounted on the handle for initiating the reading and for actuating the controller to control the data capture assembly.

3. The reader of claim 1, wherein the data capture assembly includes a laser for emitting the light as a laser beam, a scanner for sweeping the laser beam across the target as a plurality of scan lines for reflection and scattering as the return light, and a detector for detecting the return light.

4. The reader of claim 3, wherein the controller is operative for driving the laser at an increased power level during the at least one scan, and at a decreased power level during the at least other scan.

5. The reader of claim 4, wherein the controller is operative for driving the laser to alternate between the increased power level and the decreased power level during the successive scans.

6. The reader of claim 4, wherein the controller is operative for driving the laser such that the increased power level is a constant and the same for a first group of alternate scans, and the decreased power level is also a constant and the same for a second group of alternate scans.

7. The reader of claim 1, wherein the data capture assembly includes an illuminator for emitting the light as illumination light that illuminates the target, and an imager for detecting the return illumination light in successive exposures.

8. The reader of claim 7, wherein the controller is operative for driving the illuminator at an increased power level during at least one exposure, and at a decreased power level during at least another exposure.

9. The reader of claim 8, wherein the controller is operative for driving the illuminator to alternate between the increased power level and the decreased power level during the successive exposures.

10. The reader of claim 9, wherein the controller is operative for driving the illuminator such that the increased power level is a constant and the same for a first group of alternate scans, and the decreased power level is also a constant and the same for a second group of alternate scans.

11. A method of electro-optically reading a target in a range of working distances from a reader, comprising the steps of:
directing light at a variable power level at the target in a plurality of successive scans:
detecting return light from the target; and
increasing the power level of the light during at least one of the successive scans to enable detection of the target located at an extended working distance from the reader, and decreasing the power level of the light during at least another of the successive scans to maintain an output power level within safety limits.

12. The method of claim 11, and the step of manually initiating, the reading.

13. The method of claim 11, wherein the directing step is performed by emitting the light as a laser beam from a laser, and by sweeping the laser beam across the target as a plurality of scan lines for reflection and scattering as the return light.

14. The method of claim 13, wherein the increasing step is performed by driving the laser at an increased power level during the at least one scan, and wherein the decreasing step is performed by driving the laser at a decreased power level during the at least other scan.

15. The method of claim 14, wherein the increasing step is performed alternately with the decreasing step during the successive scans.

16. The method of claim 15, wherein the increasing step is performed such that the increased power level is a constant and the same for a first group of alternate scans, and the decreased power level is also a constant and the same for a second group of alternate scans.

17. The method of claim 11, wherein the directing step is performed by emitting the light as illumination light that illuminates the target from an illuminator, and wherein the detecting step is performed by exposing an imager to the return illumination light in successive exposures.

18. The method of claim 17, wherein the increasing step is performed by driving the illuminator at an increased power level during at least one exposure, and wherein the decreasing step is performed by driving the illuminator at a decreased power level during at least another exposure.

19. The method of claim 18, wherein the increasing step is performed alternately with the decreasing step during the successive exposures.

20. The method of claim 19, wherein the increasing step is performed such that the increased power level is a constant and the same for a first group of alternate exposures, and wherein the decreasing step is performed such that the decreased power level is also a constant and the same for a second group of alternate exposures.
